(19) United States
(12) Patent Application Publication
(10) Pub. No.: US 2025/0116153 A1
(43) Pub. Date: Apr. 10, 2025

(54) DOOR/WINDOW FRAME STRUCTURE AND THE METHOD FOR MAKING SUCH A DOOR/WINDOW FRAME STRUCTURE

(71) Applicant: SERRAMENTI BROMBAL S.R.L., Altivole (TV) (IT)

(72) Inventor: Pietro BROMBAL, Altivole (TV) (IT)

(21) Appl. No.: 18/833,837

(22) PCT Filed: Jan. 27, 2023
(86) PCT No.: PCT/IB2023/050727

§ 371 Date: Jul. 26, 2024

(30) Foreign Application Priority Data
Jan. 27, 2022 (IT) 102022000001403

(51) Int. Cl. E06B 3/263; E06B 3/16

(52) U.S. Cl. CPC E06B 3/26303; E06B 3/16; E06B 3/26305; E06B 2003/26352

(57) ABSTRACT

A door/window frame structure for making door/window casing such as doors and/or windows intended to be anchored to a supporting wall, said structure comprising at least one metal end element (2) suited to define the external surface (3) of the door/window frame and a substantially straight insulating element (4) suited to promote thermal insulation between the environments respectively located inside and outside with respect to the door/window frame structure. At least one pair of straight metal profile (13) is provided, which have a first end (16) intended to be directly coupled with the insulating element (4); at least one of the profiles of said pair has a second end (19) suited to be directly anchored to the metal end element (2).

### FIELD OF APPLICATION OF THE INVENTION

The present invention concerns the technical field of door/window frames and doors/windows casing, and the subject of the invention is a door/window frame structure for making doors and windows. The subject of the invention also includes a method for making said door/window frame structure.

### STATE OF THE ART

As is known, the door/window frame structures used in the technical field of doors and/or windows casing require the use of a pair of frames, the first of which is intended to be anchored to a wall of the building in a stable manner while the second is movable with respect to the first so that it can be selectively coupled with the latter.

The techniques for making door/window frame structures have evolved continuously over time, to the point that today various types of door/window frames are available on the market and each of them has its own specific characteristics.

A first configuration of a door/window frame involves the use of a metal frame obtained from conveniently shaped pieces of metal profile.

These pieces of metal profile define both parts of the door/window casing (the fixed portion and the movable portion) and their cross-sectional shape is selected in such a way as to promote the creation of walls and surfaces suited to allow the frame to be anchored to the wall of the building and at the same time a glass pane or a door panel to be supported.

The metal profiles used to make these door/window frame structures are generally obtained by means of a drawing process, using molds that are shaped according to the specifications provided by the manufacturer of the door/window casing.

It is common to use an insulating element suited to promote thermal insulation between the internal and the external environment with respect to the door/window casing.

In particular, the insulating elements serve the function of defining a “thermal break” between the two parts of the structure.

The insulating elements are generally made of polymeric material and are interposed between the inner walls of the frame that are obtained using the metal profile.

A second type of door/window frame involves the use of frames obtained from metal profiles consisting of pieces of linear metal sheet conveniently folded so that to have a predetermined cross-sectional shape.

In this case, therefore, the metal profiles are not of the extruded type but are obtained through a bending and flanging step (carried out with bending and flanging machines), through which the profile can be given a predetermined shape and mechanical strength.

In general, the bent and shaped profile has an end suited to hold the insulating element, for example it is possible to provide an open end of the profile, inside which the end portion of the insulating element is inserted.

The insulating element can be locked onto the metal profile by interference or by making an edge at specific areas of the profile.

A further type of door/window frame involves the use of structures having substantially rectangular or square frames obtained from flat metal profile.

The insulating element is connected to said structures by means of a plurality of retaining pins distributed along the extension of the frame.

This type of door/window frame is described in European Patent EP2581537 and U.S. Pat. No. 8,572,929 filed in the name of Arcadia, Inc.
These documents describe a window or door element provided with a metal frame and an insulating glass pane inserted in the frame.
The external and/or internal surface of the frame is constituted by a metal plate and the insulating element body is arranged between the frame elements in a layered configuration.

The insulating element is anchored to the frame by means of blind holes into which corresponding pins (or studs) are inserted, welded to the metal plate making up the frame and projecting from said metal plate.

A first drawback of this solution lies in that it is difficult to carry out, as it is necessary to respectively provide the frames, a series of through holes, respectively a series of pegs or pins along the outline of the insulating element.

Furthermore, the solution described in these patents requires that many elements, first and foremost the insulating element, are made specifically for this purpose and therefore it is not sufficiently standardised from the point of view of large-scale production.

A further drawback of the solution described above lies in that the processing steps carried out during the manufacture of the components are rather delicate, as they require a high degree of precision.

Consequently, the door/window frame structure that is the subject of the above-mentioned patents has a significantly high production cost, which is also determined by the fact that the installation of the elements of the structure requires special care.

Finally, this door/window frame structure has limited duration over time and during its life cycle it may need maintenance due to the frequent infiltration of water or moisture into the holes obtained on the insulating element.
Documents NL 2 006 489, EP 2 476 853, WO 2015/089678, CN 112 343 460 and IT102015000029272 describe door/window frame structures made up of a metal end element, an insulating element and a pair of profiles. However, the door/window frame structures described in these documents also have the same drawbacks already illustrated above.

### PRESENTATION OF THE INVENTION

The present invention intends to overcome the technical drawbacks described above by providing a particularly efficient and high-performance door/window frame structure for making doors and windows.

More specifically, the main object of the present invention is to provide a door/window frame structure for making doors and windows that is particularly resistant and durable as well as capable of maintaining its thermal and acoustic insulation properties unaltered over time.

A further object of the present invention is to provide a door/window frame structure for making doors and windows that minimizes the need for maintenance activities after its installation.

Another object of the present invention is to provide a door/window frame structure for making doors and windows that is particularly simple to construct and is made up of a limited number of components.

A further object of the present invention is to provide door/window frame structure for making doors and windows that is particularly versatile in use and can therefore be used to make many types of doors/windows casing.

Another object of the present invention is to provide a door/window frame structure for making doors and windows that has significantly low production and installation costs.

Still, it is not the least object of the present invention to provide a door/window frame structure for making doors and windows that has also a particularly pleasant design.

These objects, together with others that are better clarified below, are achieved by a door/window frame structure for making doors and windows of the type according to claim 1.

Other objects that are better described below are achieved by a door/window frame structure for making doors and windows according to the dependent claims.

The subject of the invention also includes a method for making a door/window frame structure according to claim 16.

### BRIEF DESCRIPTION OF THE DRAWINGS

The advantages and characteristics of the present invention clearly emerge from the following detailed description of some preferred but non-limiting configurations of a door/window frame structure for making doors and windows with particular reference to the following drawings:

FIG. 1 shows a side sectional view of a door/window frame structure according to a first embodiment of the invention;

FIG. 2 shows a side sectional view of a door/window frame structure according to a first embodiment of the invention;

FIG. 3 shows a side sectional view of an insulating element used in the structure shown in FIG. 1 and FIG. 2;

FIGS. 4a-4d show side sectional views of the assembly used in the structure shown in FIG. 1 and FIG. 2 comprising the insulating element anchored to the pair of metal profiles;

FIG. 5 shows a side sectional view of a door/window casing installed on a wall of a building and obtained by means of the structures that are the subject of the present invention;

FIG. 6 shows a side view of an alternative configuration of a door/window frame structure according to the invention.

### DETAILED DESCRIPTION OF THE INVENTION

The subject of the present invention is a door/window frame structure for making doors and windows.

This structure, hereinafter referred to by the reference number 1, can be used to make a plurality of doors/windows casing and is intended to be anchored to a wall of an edifice or of a building.

By way of example, the structure 1 that is the subject of the present invention can be used to make windows and doors, whether swing doors or sliding doors, dormer windows, verandas and other similar casing.

Furthermore, as is known in the technical field of door/window production, some doors/windows casing can consist of a single fixed frame that may be anchored to the wall.

Other types of doors/windows casing, on the other hand, require the use of a pair of frames: a fixed frame (suited to be anchored to the wall of a building) and a movable frame that can be coupled with the fixed frame (suited to form, for example, the movable part of a window or door).

The expression “door/window frame structure” used in the present description refers to a configuration of elements suited to make a single frame of a door/window frame.

In particular, the fixed frame of a door/window casing can be made by means of a door/window frame structure 1 according to the present invention, while a door/window casing consisting of two mutually coupled frames (one fixed and the other movable) may be made by means of two respective door/window frame structures 1 according to the present invention.

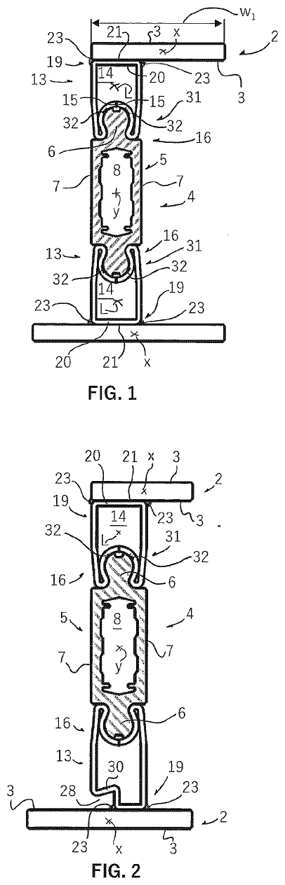

As is better illustrated in FIG. 1 and FIG. 2, the door/window frame structure 1 comprises at least one metal end element 2 suited to define the outermost part of the door/window frame.

The metal end element 2 can consist of a flat metal profile having a pair of substantially parallel faces 3. One of said faces 3 of the metal element is suited to define the outer surface of the door/window frame structure.

Conveniently, the metal end element 2 can be made of a solid profile in such a way as to provide adequate mechanical strength to the entire door/window frame structure.

The metal end element 2 may have an elongated configuration extending along a longitudinal direction X.

With reference to FIG. 1 and FIG. 2, the direction of extension of the end element is indicated by the reference letter X and its orientation is substantially perpendicular to the plane on which the image lies.

The width w₁ of the flat profile defining the end element 2 may be chosen in such a way as to be included between a predetermined minimum and maximum value, typically between 10 mm and 100 mm.

The thickness p₁ of the flat profile defining the element 2 may instead be included between 3 mm and 7 mm and preferably be close to 4 mm.

The flat profile used to define the end element 2 may be made of stainless steel or other types of steel with high resistance to oxidation and corrosion.

Conveniently, the profile used to make the metal end element 2 is typically of the type available on the market and therefore can be selected from among those produced according to EN (European Standards) or ISO (International Organisation for Standardisation) standards.

The edges of this profile may also be slightly rounded with a very small radius, typically shorter than 0.5 mm.

In the door/window frame structure 1 shown in the Figures, there is a pair of metal end elements 2 suited to define the ends (or the outermost areas) of the structure itself.

One of the faces 3 of each metal end element 2 defines the outer surface of the structure 1.

The use of a flat profile makes it possible to obtain an external surface of the structure (and thus an outer surface of the door/window frame) that is substantially flat.

FIG. 1B shows an alternative version of the door/window frame structure that is the subject of the present invention, in which a single straight metal element 2 is used.

The structure 1 furthermore comprises a substantially straight insulating element 4 made of polymeric material.

As is known, the door/window frame structure 1 serves the function of selectively closing an opening made in a wall of a building; said structure 1, therefore, is exposed to thermal contact with two distinct environments: a first environment located inside the building and a second environment located outside the building.

The door/window frame structure 1 must therefore promote thermal insulation between these two environments, and the straight insulating element 4 inserted in said structure 1 makes it possible to achieve this object thanks to the fact that it is made of thermally insulating polymeric materials.

In other words, the insertion of the insulating element 4 in the structure 1 makes it possible to produce a “thermal break” between the inside and the outside of the door/window casing.

The insulating element 4 may have a straight extension direction Y that is substantially longitudinal and parallel to the extension direction X of the metal end element 2.

Conveniently, the insulating element 4 may be made of a nylon-filled material of type PA66 (polyamide 66).

Alternatively, the insulating element 4 may include a predetermined percentage by weight of glass fibre.

In the case at hand, for example, the material used to make the insulating element 4 may be a PA66-based mixture with the addition of glass fibre in a percentage of 25%.

Preferably, the insulating element 4 may be positioned in the space defined between two metal end elements 2.

This configuration is clearly illustrated in FIG. 2, as well as in Figures from 5 to 7.

The insulating element 4 can be a profile obtained through a polymeric material drawing process.

Conveniently, the insulating element 4 can be made up of a central portion 5 and a pair of end portions 6.

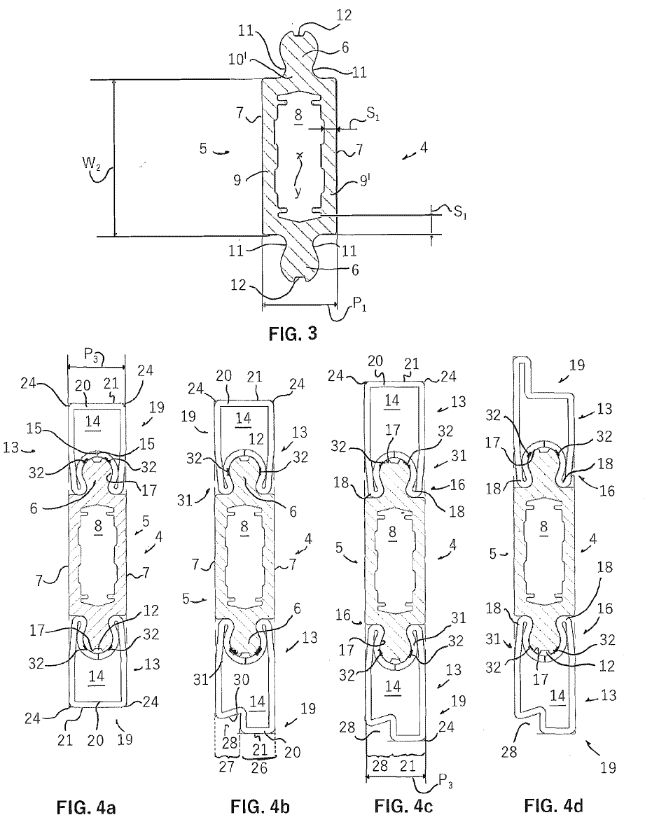

As better illustrated in FIG. 3, the central portion 5 may have a substantially rectangular cross-sectional shape.

More specifically, the central portion 5 may have a pair of substantially parallel outer surfaces 7 whose width w₂ is included between 20 mm and 30 mm.

The thickness p₂ of the central portion 5, instead, may be included between 8 mm and 20 mm.

A cavity 8 extending over the entire length of the insulating element 4 may be created in the central portion 5.

This cavity 8 may have a predetermined sectional shape (obtained as a result of the drawing process), the dimensions of which are such that it takes up most of the internal volume occupied (or enclosed) by the central portion 5.

In general, the volume of the cavity may take up at least 75% of the entire volume enclosed by the central portion 5.

The cavity 8 of the central portion 5 may thus be defined by two pairs of substantially parallel walls 9, 9′; 10, 10′ (so as to give said portion 5 a substantially rectangular shape), each of which has a predetermined thickness s₁.

For example, each of said walls 9, 9′; 10, 10′ can have a thickness s₁ close to 2 mm.

The internal cavity 8 of the insulating element 4 fulfils a dual function: i) it makes it possible to increase the thermal and acoustic insulation that said element 4 can provide to the structure 1, ii) it makes it easier to install the structure itself on the wall of the building, as is described in greater detail further on the present description.

The insulating element 4 is also provided with a pair of end portions 6 joined to the central portion 5.

More specifically, these portions 6 are substantially longitudinal and extend over the entire length of the insulating element 4 in addition to being joined to the central portion 5 at the pair of walls 10, 10′ suited to define the thickness p₂ of the insulating element 4.

The end portions 6 of the insulating element 4 are configured so that they have a predetermined shape.

Advantageously, said end portions 6 may have a substantially circular or semicircular cross section.

In fact, it has been possible to observe experimentally that an insulating element 4 provided with ends 6 whose cross section has a circular or semicircular shape makes it possible to obtain a good technical compromise in terms of mechanical rigidity and ease of coupling with the other components of the structure.

As is better described below, in fact, the end 6 of the insulating element 4 is coupled with a metal profile so as to obtain a unitary component.

A semicircular design of the ends respectively associated with the insulating element 4 and the metal profile facilitates the coupling operations between these elements while at the same time providing high mechanical resistance to the unitary assembly obtained.

In the version of the structure illustrated in FIG. 3, both the end portions 6 are substantially circular in shape and in the area connecting the central portion 5 there is a radiused zone defining a connecting portion 11 having slightly smaller dimensions with respect to those of the end portions 6.

Conveniently, each end portion 6 may be provided with a small straight recess 12 obtained in top part thereof.

This recess may extend over the entire length of the insulating element 4.

According to a specific aspect of the invention, the door/window frame structure 1 comprises a pair of straight metal profiles 13.

These profiles 13 are clearly visible in Figures from 1 to 4d.

Each metal profile 13 may extend along a longitudinal extension direction L.

Conveniently, each profile 13 may be obtained from a piece of flat metal sheet (whose thickness is generally included between 1 mm and 3 mm) subsequently bent and shaped to define a predetermined cross-sectional shape.

More specifically, the pair of profiles 13 can be obtained by bending a sheet made of stainless steel or another metallic material resistant to oxidation.

In the configuration of the structure 1 illustrated in the Figures, the profiles have a closed cross-sectional shape obtained by bending a metal sheet, thus generating a cavity, indicated by the reference number 14 in the Figures, in the inner area of the profile.

The step of bending the profiles 13 may be performed by means of bending machines configured in such a way as to perform a series of folds on the same piece of metal sheet, said folds being designed in such a way as to join (or bring into contact with each other) the free edges 15 of the metal sheet so as to define a closed cross-sectional shape.

Each profile may have a predetermined thickness p₃, selected so that it is substantially equal to the thickness p₂ of the insulating element 4.

For example, the thickness p₃ of the profiles 13 can be included between 8 mm and 20 mm.

Each profile 13 is provided with a first end 16 intended to interact with the end portion 6 of the insulating element 4.

The first end 16 of the profile 13 may have a cross-sectional shape substantially counter-shaped with respect to the shape of the end portion 6 of the insulating element 4.

According to the configuration of the structure illustrated in Figures from 1 to 4d, the first end 16 of the profile 13 may have a substantially circular or semicircular cross-sectional shape.

Conveniently, the first end 16 of the metal profile 13 may be shaped so as to enclose a longitudinal seat 17 suited to allow the shaped end portion 6 of the insulating element 4 to be at least partially inserted therein.

The seat 17 also has a semicircular shape so as to allow the coupling with the end 6 of the insulating element 4.

As already described above, the decision to choose a semicircular shape for both the end 6 of the insulating element 4 and the seat 17 obtained on the first end 16 of the profile 13 respectively has the following advantages: i) it allows an easy coupling of the two components (the semicircular shape facilitates the sliding movement and/or the lateral or bottom-to-top insertion of the end 6 of the insulating element into the seat 17), ii) it maintains the mechanical resistance of this coupling high.

In the case illustrated in the Figures, even the first end 16 of the profile 13 is obtained through a bending step that is carried out starting from a piece of metal sheet, and it is precisely at this end 16 that the joining of (or contact between) the free edges 15 of the metal sheet takes place.

Furthermore, the free edges 15 of the metal sheet are substantially joined in the innermost area of the seat 17 defined by the shaping of the first end 16 of the profile 13, said position being selected in such a way as to ensure the alignment with the recess 12 formed on the end portion 6 of the insulating element 4 when the latter is inserted in the seat.

In this way, it is possible to insert the end portion 6 of the insulating element 4 without jamming or blocking that could be caused by a slight transverse misalignment of the free edges 15 of the metal sheet.

A non-perfect alignment of the edges 15, in fact, could create small steps or projections inside the seat that would not allow the insertion of the end portion 6 of the insulating element 4 (or would make it difficult) if the latter were completely solid and without the recess 12.

In order to promote the coupling of the insulating element 4 with the profile 13, the first end 16 of the latter may undergo a flanging step suited to slightly tighten the edges of the metal sheet 18 that define the entrance of the seat 17; in this way, the coupling of the first end 16 with the reduced-size connecting portion 11 present in the insulating element 4 is promoted.

The coupling of the profile 13 with the end portions 6 of the insulating element 4 is clearly visible in Figures from 4a to 4d.

In this case, as in all the other Figures showing the structure 1 that is the subject of the present invention, there are two profiles 13, each of which is provided with a respective first end 16 intended to be coupled (and to promote mechanical anchorage) with the corresponding shaped end portion 6 of the insulating element 4.

The door/window frame structure may also comprise holding means, indicated in the Figures by the reference number 31 and suited to hold the profile 13 onto the insulating element 4 in a stable manner. Thus, the function of the holding means 31 is to increase the mechanical strength of the coupling acting between the profile 13 and the insulating element 4.

Conveniently, the holding means 31 may comprise one or more knurls 32 obtained in the internal wall that delimits the seat 17 formed on the first end 16 of the profile 13.

More specifically, said knurls 32 are obtained on the surface of the metal sheet that delimits the cavity of the seat 17, so that the knurled part of the latter may come into contact with the end 6 of the insulating element 4 so as to increase the holding action between these two components.

Furthermore, the knurl 32 may affect the entire surface of the metal sheet that delimits the seat 17 internally, or only on a limited part of the latter.

For example, the surface delimiting the seat 17 can be provided with several knurled areas 32, spaced from one another by smooth areas, each of which extends over the entire length of the profile 13.

Conveniently, the metal profiles 13 can have a second end 19 positioned opposite the first end 16.

In the configurations of the profile shown in FIGS. 1, 2 and 5, the second end 19 is at least partially defined by a flat transverse wall 20 intended to come into contact with the metal end element 2.

In particular, the transverse wall 20 defining the second end 19 of the metal profile 13 can have an outer surface 21 intended to come into contact (and thus be coupled) with the external surface 3 of the metal end element 2 facing towards the profile 13.

First fixing means 22 are also provided, which are suited to promote the permanent anchorage of the metal profile 13 to the corresponding end element 3.

In the configuration of the structure illustrated in the Figures, the first fixing means 22 may consist of one or more weld beads 23 arranged longitudinally along a direction that is substantially parallel to the extension direction L of the profile.

The weld beads 23 promote the permanent joining of the second end 19 of the metal profile 13 to the external surface 3 of the metal end element 2 facing towards the profile itself.

The outer surface 21 of the wall 20 defining the second end 19 of the profile 13 has a slightly rounded (or radiused) edge, in such a way that when this wall 20 is in contact with the external surface 3 of the end element 2 a small groove 25 having significantly reduced dimensions is created, which extends longitudinally over the entire length of the profile 13.

The size of this groove 25 may be included between 0.5 mm and 1.5 mm.

The weld beads 23 may be laid inside said grooves 25, so that they are extremely small, too.

In this way, it is possible to maintain a high degree of visual cleanliness of the door/window frame structure 1 while at the same time favouring high adhesion of the weld to both the profile 13 and the end element 3.

Preferably, weld beads may be carried out by means of a laser welding process, that is, a cold welding process.

Furthermore, the contact between the second end 19 of the profile 13 and the face 3 of the metal end element 2 may create a pair of grooves 25, each of which may be filled with a respective weld bead 23.

The groove 25 and the weld bead 23 are both visible in FIG. 1 and FIG. 2.

According to a first configuration of the invention, the two profiles 13 used to make the structure may be substantially equal to each other and provided with a second end 19 having a transverse wall 20 whose outer surface 21 has an extension that is equal to the entire thickness p₃ of the profile 13.

In this case, therefore, even the contact between the profile 13 and the metal end element 2 involves the entire surface 21 and therefore its extension is equal to the thickness p₃ of the profile 13.

This configuration is illustrated in FIG. 1 and in FIG. 4a.

According to an alternative configuration of the invention, the transverse wall 20 defining the second end 19 may have a flat transverse portion 26 whose dimensions are smaller compared to the thickness p₃ of the profile 13.

This portion 13 is provided with the outer surface 21 intended to directly come into contact with the external surface 3 of the end element 2.

The remaining portion 27 of the wall 20 defining the second end 19 of the profile 13 can be conveniently shaped so as to define, in cooperation with the end element 2 when the latter is joined to the profile 13, a housing 28 for a linear gasket 29.

This configuration is illustrated in FIG. 2 and in Figures from 4b to 4d.

The use of a linear gasket 29 is in fact required in many types of door/window frame structures 1, the function of this gasket 29 being to prevent water or moisture from getting into the indoor environment in which the door/window casing is installed.

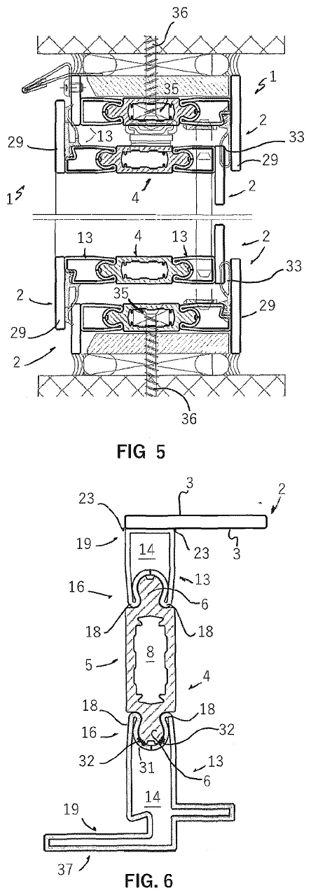

The linear gasket 29 is visible in the door/window frames illustrated in FIG. 5 and FIG. 6.

In addition, the gasket 29 may have various operating configurations; in the door/window casing shown in FIG. 5 two different types of gasket are used: the first type involves the creation of a lip seal, while the second type (referred to as a “balloon gasket” in technical jargon) has an external wall suited to define an air-filled inner cavity (indicated by the reference number 33 in the Figure).

Conveniently, the housing 28 for the linear gasket 29 may be formed with an undercut 30 that is useful for defining a fixed joint for the gasket itself and making it easier to hold it during the movement of the door/window frame structure 1 or during the coupling of two different structures 1.

Similarly to what has already been described with reference to the other parts of the profile 13, even the second end 19 (whether or not provided with the housing 28) can be obtained from a metal bending step carried out with suitable bending machines starting from a piece of metal sheet.

FIG. 5 shows a door/window casing made up of two door/window frame structures 1 of the type described above. In particular, the outermost door/window frame structure 1 is anchored to the wall of a building in which a corresponding opening has been formed.

The innermost door/window frame structure 1, on the other hand, is anchored to the outer structure so as to be movable with respect to the latter.

Both structures 1 consist of an assembly obtained, respectively, from the union of a pair of metal end elements 2 with respective profiles 13 having first ends 16 coupled with the ends 6 of an insulating element 4 made of polymeric material.

In addition, the profiles 13 of each structure 1 are provided with a second end 19 shaped in such a way as to define a housing 28 for two linear gaskets 29, respectively a lip seal and a balloon gasket.

The fixed structure 1 is anchored to the wall by means of respective anchoring screws 34 whose head 35 is inserted in the cavity 8 of the insulating element 4.

The rod 36 of the screws 34 extends crosswise with respect to the direction of extension of the insulating element 4 and projects from the profile through a lateral hole drilled in the same (not visible in FIG. 5).

In this way, the rod 36 of the screw 34 may be screwed into a dowel inserted in a passage formed on the wall.

FIG. 6 shows an alternative version of a door/window frame structure 1 according to the present invention.

In this case, the door/window frame structure 1 is provided with a single metal end element 2 joined to a first metal profile 13 of the type described above by means of a pair of weld beads. This profile is provided with a second end 19 obtained by means of a flat transverse wall 20.

There is also a further profile 13 with a second end 19 shaped in such a way as to define a transverse portion 37 suited to constitute an external wall of the door/window frame structure 1.

In this case, therefore, the external surfaces of the structure 1 are respectively associated with the face 3 of the end element 2 and with the transverse portion 37 of one of the two metal profiles 13.

Similarly to what has already been described, the transverse portion 37 of the profile 13 can be obtained through a bending step carried out on the piece of metal sheet from which the profile itself has been obtained.

Analogously to what has already been described with reference to the other configurations, both profiles 13 used in the structure shown in FIG. 6 delimit a closed cavity 14 and have a first end 16 suited to define a semicircular seat 17 intended to house the respective end 6 of the insulating element 4 (also semicircular in shape).

According to a further aspect of the invention, a method for producing a door/window frame structure of the type described above is provided.

The method comprises, first of all, a step a) of providing at least one metal end element 2, a step b) of providing an insulating element 4, and a step c) of providing a pair of straight metal profile 13 (or at least one pair of such profile 13), each of which provided with a pair of ends 16, 19.

The metal end element 2, the insulating element 4 and the straight metal profiles 13 obtained through steps a)-c) are all of the type already described above.

Subsequently, there is a step d) of coupling the insulating element 4 with an end 16 of each metal profile 13 arranged during the execution of step c).

The ends 16 of the straight metal profiles 13 are counter-shaped with respect to the ends 6 of the insulating element 4 so as to allow these two elements 2, 13 to be coupled with each other.

In the configuration of the insulating element 4 illustrated in the Figures, the ends 6 have a substantially semicircular cross-sectional shape and, consequently, the ends 16 of the profiles 13 must also have a substantially semicircular cross-sectional shape, so as to define a (semicircular) seat 17 suited to house the ends 6 of the insulating element.

The profiles 13 comprise a pair of edges 18 suited to delimit at the bottom the seats 17, said edges 18 being spaced from each other so as to define an opening for the insertion of the end 6 of the insulating element 4 in said seat 17.

Advantageously, the distance between the edges 18 is greater than the diameter of the semicircular seat 17. In this way, the opening delimited by the edges 18 has a greater extension than the seat 17, meaning that the extension of said opening exceeds the diameter of the seat 17.

Thanks to this characteristic, it is possible to define a step d) of coupling of the end 6 of the insulating element 4 with the end 16 of the profile 13 in which the seat 17 has been made.

More specifically, the coupling step d) comprises a first sub-step d′) during which the end 6 of the insulating element 4 is inserted in the seat 17 formed on the end 16 of the profile 13.

More specifically, in view of the fact that the edges 18 of the profile 13 define a wider opening compared to the diameter of the seat 17, during the execution of step d′) it is possible to insert the end 6 of the insulating element 4 into the seat 17 laterally or from below.

In other words, the special configuration of the end 16 of the profile 13 makes it easier to house the shaped end 6 of the insulating element 4 in the seat 17 through the insertion of the element 4 from any direction (laterally or from below), without requiring that the end 6 has to be fitted (meaning retained by means male-female joint or the like) in the seat 17 obtained on the end 16 of the profile 13.

Conveniently, the coupling step d) also comprises a further sub-step d″) suited to promote the tightening or the approach of the edges 18 of the end 16 of the profile 13 after the insertion of the end 6 of the insulating element 4 in the seat 17.

During the execution of step d″), the edges 18 are mutually moved inwards (or tightened) so as to allow the semicircular end 6 of the insulating element 4 to be retained in (and consequently coupled with) the countershaped seat 17 obtained on the profile 13.

In general, step d′) can be performed manually or automatically by means of suitable machines, while the execution of step d″) requires the passage of the assembly made up of profile-insulating element (4-13) in a roller system suited to interact with the edges 18 of the end 16 so as to promote their mutual approach towards the inside.

Subsequently, there is a step e) of positioning at least one metal end element 2 on the end 19 of the profile 13 that is not coupled with the insulating element 4.

During the execution of step e), the external surface 3 of the metal element 2 comes into contact with the outer surface 21 of the profile 13 that defines the end 19.

After this positioning step, there is a step f) during which the joining of the metal element 3 with the profile 13 is promoted by means of one or more weld beads 23 arranged in proximity to the end 19 of the profile 13.

The weld beads 23 may extend along a substantially longitudinal direction L and may be continuous (that is, cover the entire extent of the profile 13 without interruptions) or be defined by a plurality of spaced sections.

Step c) of the method illustrated above may include respective sub-steps suited to make a profile 13 of the type described above.

More specifically, there can be a sub-step g) of providing a piece of flat metal sheet.

The piece of metal sheet provided during sub-step g) may extend along a longitudinal extension direction L and has a pair of substantially straight end edges.

There is also a sub-step h) of bending the piece of metal sheet according to predetermined bending lines.

More specifically, during sub-step h) the piece of metal sheet may be bent so as to obtain a profile 13 that extends along a longitudinal extension direction L substantially parallel to or coinciding with the extension direction of the initial piece of metal sheet.

When all the folds have been made, sub-step i) of the method is carried out, during which the end edges of the previously bent metal sheet are joined to each other.

At the end of step i) an internally hollow metal profile 13 with a closed cross section is obtained, entirely similar to that shown in the Figures.

At the end of step i), furthermore, the profile 13 has a pair of shaped ends 16, 19, whose characteristics have already been exhaustively described above with reference to a door/window frame structure according to the present invention.

The present invention can be carried out in other variants, all falling within the scope of the inventive features claimed and described herein; said technical features can be replaced by different technically equivalent elements and materials; the shapes and dimensions of the invention can be any as long as they are compatible with its use.

The reference numbers and signs included in the claims and in the description are only intended to make the text clearer to understand and must not be considered as elements limiting the technical interpretation of the objects or processes identified by them.

1. Door/window frame structure for making door/window casing suited to be anchored to a supporting wall, said structure comprising:
at least one metal end element (2) suited to define the outer surface (3) of the door/window frame;
a substantially straight insulating element (4) suited to promote thermal insulation between the environments located, respectively, inside and outside with respect to the door/window frame structure;
at least one pair of straight metal profiles (13) having a first end (16) suited to be directly coupled with said insulating element (4); at least one profile (13) of said at least one pair having a second end (19) suited to be directly anchored to said metal end element (2),
characterized in that each profile (13) of said pair is internally hollow and has a closed cross-sectional shape.

2. Structure according to claim 1, characterized in that said at least one end element (2) consists of a flat metal profile having a pair of substantially parallel outer faces (3).

3. Structure according to claim 1, characterized in that said insulating element (4) is a profile provided with a central portion (5) and a pair of shaped ends (6) having a predetermined shape and arranged on the opposite side with respect to said central portion (5).

4. Structure according to claim 1, characterized in that the first end (16) of the metal profiles (13) of said at least one pair is substantially counter-shaped with respect to the shape of the end (6) of said insulating element (4).

5. Structure according to claim 4, characterized in that said first end (16) of the metal profile (13) of said at least one pair is suited to define a seat (17) that is substantially counter-shaped with respect to the shape of the ends (6) of said insulating element (4), said seat (17) being suited to allow the at least partial insertion of the shaped end (6) of said insulating element (4).

6. Structure according to claim 1, characterized in that each end (6) of said pair has a substantially circular o semicircular shape.

7. Structure according to claim 6, characterized in that the seat (17) obtained on the first end (16) of the metal profile (13) of said at least one pair has a substantially circular or semicircular cross-sectional shape.

8. Structure according to claim 1, characterized in that it comprises means (31) suited to hold the end (6) of said insulating element (4) within said seat (17) formed at said first end (16) of the metal profiles (13) of said at least one pair.

9. Structure according to claim 8, characterized in that said holding means (31) comprise a knurl (32) made on the surface of said first end (16) delimiting said seat (17).

10. Structure according to claim 1, characterized in that each metal profile (13) of said at least one pair extends along a substantially straight longitudinal extension direction (L).

11. Structure according to claim 10, characterized in that the second end (19) of at least one of said profiles (13) consists of a transverse wall (20) having an at least partially flat outer surface (21) suited to come into contact with a corresponding face (3) of said metal end element (2).

12. Structure according to claim 1, characterized in that it comprises first fixing means (22) suited to anchor at least one of said metal profiles (13) to said metal end element (2).

13. Structure according to claim 12, characterized in that said first fixing means (22) comprise one or more weld beads (23) extending along a longitudinal direction that is substantially parallel to the extension direction of said profile (13), said one or more weld beads (23) being suited to promote the permanent anchorage of said second end (19) of the profile (13) to said metal end element (2).

14. Structure according to claim 1, characterized in that it comprises one or more linear gaskets (29).

15. Structure according to claim 14, characterized in that said second end (19) of said at least one metal profile (13) has a substantially flat portion (26) suited to come into contact with a corresponding face (3) of said metal end element (2) and a shaped portion (27) suited to define a housing (28) for said linear gasket (29).

16. A method for making a door/window frame structure of the type according to claim 1, comprising the following steps:
a) providing at least one metal end element (2);
b) providing an insulating element (4);
c) providing a pair of straight metal profile (13), each profile (13) of said pair being provided with a pair of ends (16, 19);
d) coupling said insulating element (4) with one end (16) of each straight metal profile (13);
e) positioning at least one metal end element (2) in contact with the other end (19) of at least one metal profile (13) of said pair;
f) joining said at least one metal end element (2) with said profile (13) by means of one or more weld beads (23) made in proximity of the end (19) of said profile (13).

17. Method according to claim 16, characterized in that the step c) of providing at least one pair of straight metal profiles (13) provides, for each section bar, the following sub-steps:
g) providing a piece of flat metal sheet having predetermined dimensions and a pair of end edges;
h) bending said piece of metal sheet according to predetermined bending lines so as to obtain an elongated metal profile (13) extending along a longitudinal extension direction (L);
i) joining said end edges of said bent sheet in such a way as to define a internally hollow and straight metal profile (13) with closed cross section, said profile (13) being provided with a pair of shaped ends (13, 16).
